(19) United States
(12) Patent Application Publication
(10) Pub. No.: US 2005/0248165 A1
(43) Pub. Date: Nov. 10, 2005

(54) Nestable pet dish lifter

(76) Inventor: Michael Sharon, Kfar Saba (IL)

Correspondence Address: Howard R. Greenberg, 6801 Southpoint Drive, Dallas, TX, 75248, US

(21) Appl. No.: 11/124,577

(22) Filed: May 9, 2005

Related U.S. Application Data
(60) Provisional application No. 60/569,043, filed on May 10, 2004.

(51) Int. Cl. B25J 1/04

(52) U.S. Cl. 294/27.1

(57) ABSTRACT

A pet dish lifter for nesting with another pet dish lifter comprises a lifter means having an opening for receiving and supporting a pet dish over a level surface and a lifting arm affixed to the lifter means which extends upward from the level surface and away from the lifter means so as not to obstruct nesting the pet dish lifter with another one.

This application is based on and claims the benefit of U.S. Provisional Application No. 60/569,043 filed on May 10, 2004.

### BACKGROUND OF THE INVENTION

The present invention relates to pet feeders for feeding domesticated animals such as dogs and cats. With the pervasive ownership of these animals there is no paucity of these type pet feeders which generally comprise a pet dish placed on a level surface such as the floor or ground.

With the increasing ownership of these animals for companionship by older people there is a cogent need for permitting cleaning and refilling these pet dishes without requiring the user to bend down. This need has been met by employing an extended lifting arm such as disclosed in U.S. Pat. No. 5,887,545. Another important consideration is the commercial selling area needed for displaying multiple units for sale of any given product such as a pet feeder. The competition of numerous products for limited floor space warrant minimizing the space occupied by a single product. Quite often this is addressed by designing nestability into a product so that multiple units can be stacked to conserve floor space.

With the foregoing in mind, one object of the present invention is to provide a new and improved pet dish lifter. Another object is to provide a pet dish lifter capable of nesting with another one.

### SUMMARY OF THE INVENTION

The present invention of the pet dish lifter comprises a circular tapered dish having a rim for supporting the dish over a level surface. The dish is supported by a lifter means having an opening for receiving the dish. A lifting arm is affixed to the lifter means which extends upward from the level surface and outward from the lifter means so as not to obstruct nesting with another lifter means.

In a first embodiment the lifter means is a ring through which the dish is inserted. Affixed to the ring is a plurality of legs which extend outward from the ring so as not to obstruct its nestability. When effecting nesting, the rings can be rotated so as to avoid their legs from colliding with one another. In a second embodiment the lifter means is a bowl shaped receptacle having an open top and bottom with the bottom edge having an inner diameter greater than that of the top edge to afford nesting. The rim of the dish, which is inserted through the open top, has an outer diameter no greater than that of the top edge. This avoids any obstruction during nesting when the bowl shaped receptacle of a second pet feeder is placed over another one.

### BRIEF DESCRIPTION OF THE DRAWINGS

FIG. 1 is an isometric view of a first embodiment of the invention showing a single nestable pet lifter.

FIG. 2 is an isometric view of the first embodiment of the invention showing a pair of nestable pet lifters nesting with one another.

FIG. 3 is an isometric view of a second embodiment of the invention showing a single nestable pet lifter.

FIG. 4 is an isometric view of the second embodiment of the invention showing a pair of nestable pet lifters nesting with one another.

### DETAILED DESCRIPTION OF THE PREFERRED EMBODIMENTS

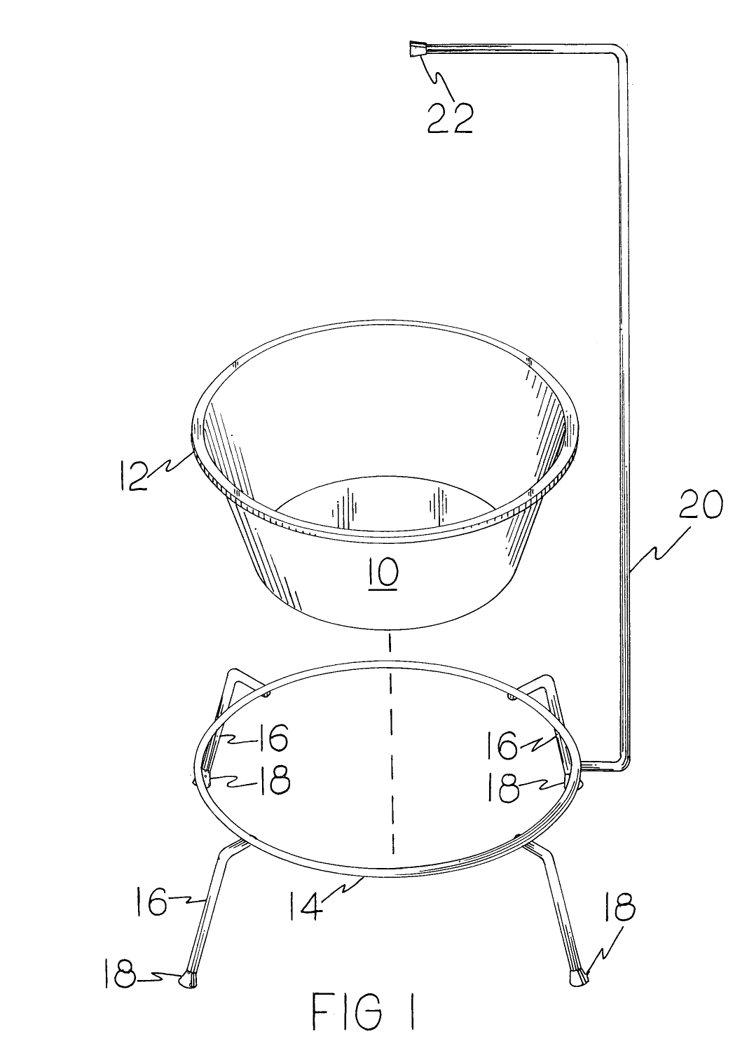

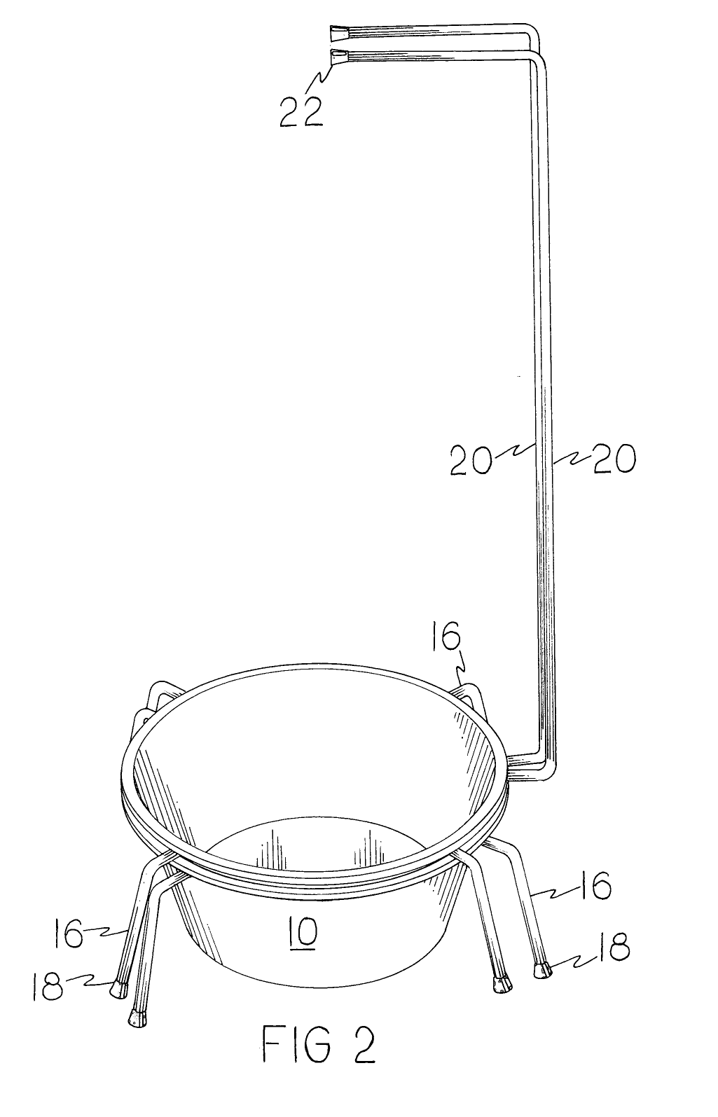

As shown in FIG. 1, the nestable pet dish lifter of the invention comprises a circular dish 10 which is tapered and has a rim 12. In the first embodiment of the invention, dish 10 is inserted through the opening of a ring 14, which may be metal, having a plurality of legs 16 affixed thereto by, for example, welding. The legs 16, which may have rubber feet 18, support ring 14 over a level surface such as the floor or ground so that an animal pet, e.g. cat or dog, can consume the contents of dish 12. It should be noted that legs 16 extend outward from ring 14 through a level section where they are affixed to ring 14 for affording nesting as explained in conjunction with FIG. 2. The inner diameter of rim 12 should be no greater than that of ring 14 so that it rests directly on ring 14 when inserted through its opening. Also, the width of rim 12 should be less than the length of the level sections of legs 16 to allow the legs of another pet feeder to rest directly thereon during nesting.

A lifting arm 20, which may be metal, is affixed to ring 12 such as by welding. Like legs 16, lifting arm 20 also has a level section where it is affixed to ring 12 so as to offer no obstruction to another pet dish lifter during nesting. Although only three legs 16 are needed for stability, four are shown for greater stability. Lifting arm 20 has a vertical section which extends upward from the level surface on which the pet dish lifter rests allowing a user to lift the ring 14 and dish 10 therein without bending to access the dish 10 for cleaning and refilling. Further convenience is afforded by terminating lifting arm 20 in a level section for an easy grip and a rubber stub 22. FIG. 2 shows a pair of nestable pet dish lifters like that of FIG. 1. Regarding the nested pair, it should be noted that the rim 12 of each dish 10 rests directly on the legs 16 of the underlying ring 14. Moreover, the legs 16 of one ring 14 and its lifting arm 20 are adjacent those of the other ring 14 making for a neat and compact nesting arrangement and optimizing the number of pet dish lifters which can be accommodated for nesting. This is done by merely rotating a pet dish lifter when nesting it with another one.

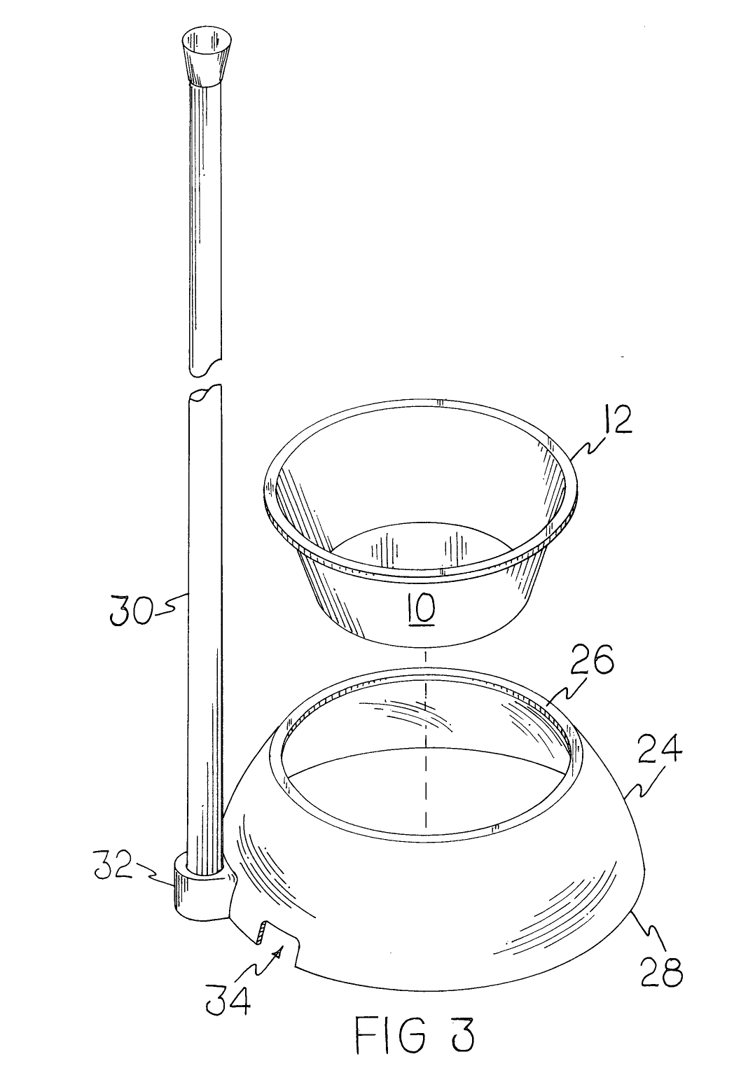

As shown in FIG. 3, a second embodiment for the lifter of the invention is a bowl shaped receptacle 24 having top and bottom openings. The rim 12 of pet dish 10 rests on the top edge 26 of receptacle 24 when the dish is inserted into the receptacle through its top opening. The outer diameter of rim 12 should be no greater than that of edge 26 so that no obstruction occurs when receptacle 24 is nested with another one. Nesting is effected by lowering one receptacle 24 over another so that the top of the lower receptacle passes through the bottom opening of the other one. To do so without any obstruction, the inner diameter of the bottom edge 28 should be greater than that of the top edge 26.

A lifting arm 30 which extends upward from the horizontal surface is affixed to receptacle 24 via a post 32 located along its bottom edge 28. Post 32 can be secured to receptacle 24 in various ways dependent on the materials employed, e.g. integral molding or by a screw for plastic or by a screw for metal. Lifting arm 30 may be secured to post 32 in various ways, e.g. by either press fitting into an aperture in the top of post 32 or screwing a threaded end into a threaded aperture. The use of post 32 serves to position arm 30 away from receptacle 24 so that it does not act as an obstruction to the placement of one receptacle 24 over another one during nesting, as it would were it directly attached to the receptacle.

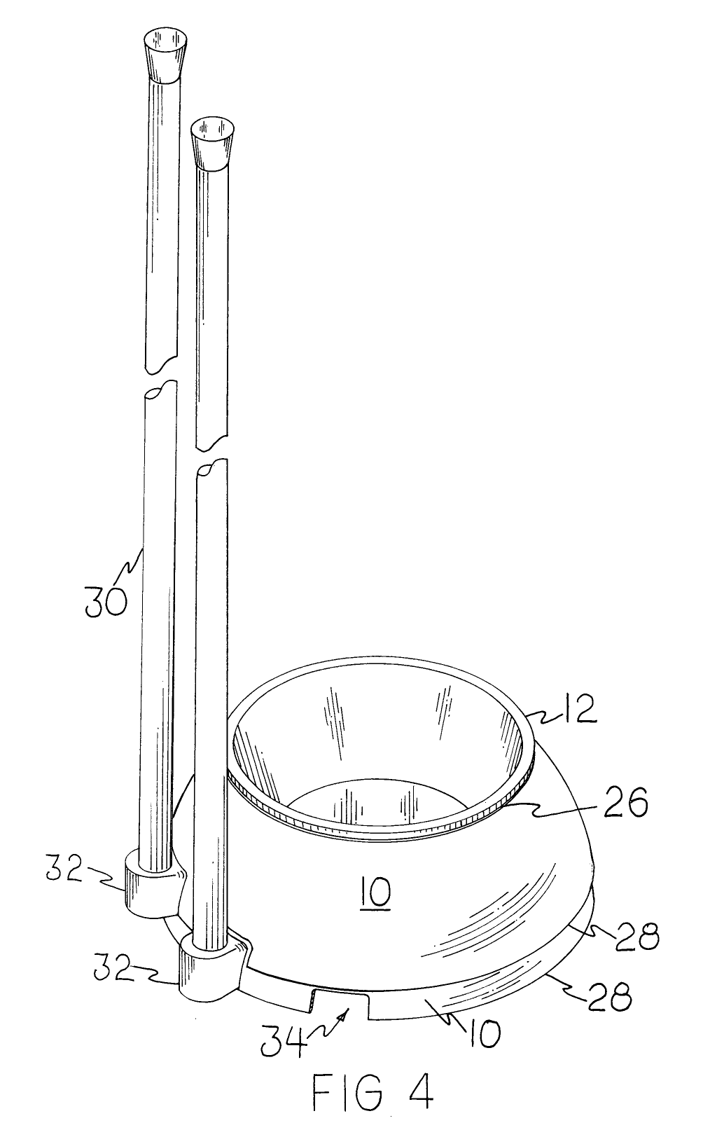

Post 32 may act as an obstruction itself during nesting dependent on various factors, e.g. the width of edges 26 and 28 of receptacle 24 and the curvature of its bowl shape. Should that be problematic, a slot 34 along the bottom edge 28 of one receptacle 24 can be employed to circumscribe the post 32 of another receptacle 32 during nesting as shown in FIG. 4.

As demonstrated by the foregoing preferred embodiments of the invention, the nestable pet dish lifter herein couples the feature of convenient lifting of a pet dish for cleaning and refilling the dish without bending by the user with the feature of nestability for conserving commercial floor space in displaying and selling multiple units thereof. Undoubtedly, modifications to the preferred embodiments may occur to those skilled in the art without departing from the invention itself. Accordingly, these embodiments are only illustrative of the invention whose scope is defined by the claims hereinbelow.

1) A pet dish lifter for nesting with another pet dish lifter, comprising:
lifter means having an opening for receiving and supporting a pet dish over a level surface, and
a lifting arm affixed to said lifter means which extends upward from the level surface and away from said lifter means so as not to obstruct nesting said pet dish lifter with another one.

2) The pet dish lifter of claim 1 wherein said lifter means is a ring with a plurality of legs.

3) The pet dish lifter of claim 2 including a circular tapered pet dish having a rim for resting on said ring.

4) The pet dish lifter of claim 1 wherein said lifter means is a bowl shaped receptacle having an open top and bottom with the bottom edge having an inner diameter greater than that of the top edge.

5) The pet dish lifter of claim 4 including a circular tapered pet dish having a rim for resting on said ring.

6) A pet dish lifter for nesting with another pet dish lifter, comprising:
a ring;
a plurality of legs affixed to and extending outward from said ring for supporting it over a level surface, and
a lifting arm affixed to and which extends outward from said ring and upward from the level surface.

7) The pet dish lifter of claim 6 including a circular tapered dish for insertion through said ring having a rim which rests on said ring whose width allows the legs of another pet dish lifter's ring to extend thereover so as not to obstruct the placement of its ring during nesting.

8) The pet dish lifter of claim 7 wherein each of said legs has a level section where it is fixed to said ring whose length is greater than the width of said rim.

9) The pet dish lifter of claim 6 wherein said lifting arm has a level section where it is affixed to said ring.

10) The pet dish lifter of claim 9) wherein said lifting arm has a 90 degree bend where its level and upward sections meet

11) A pet dish lifter for nesting with another pet dish lifter, comprising:
a bowl shaped receptacle having an open top and bottom for resting on a level surface, the bottom edge having an inner diameter greater than that of the top edge;
a lifting arm, and
means situated along the bottom edge of said receptacle for affixing said arm thereto so that it is positioned away from said receptacle and extends upward from the level surface.

12) The pet dish lifter of claim 11 including a circular tapered dish for insertion through the open top of said receptacle having a rim for nesting on its top edge and an outer diameter no greater than that of said top edge.

13) The pet dish lifter of claim 11 wherein said affixing means is a post and said receptacle has a slot along its bottom edge for circumscribing the post of another receptacle during nesting.
